(19) United States
(12) Patent Application Publication
(10) Pub. No.: US 2012/0063126 A1
(43) Pub. Date: Mar. 15, 2012

(54) PENDANT HAVING AN INDIVIDUALIZING ELEMENT

(75) Inventor: Karl-Otto Nickel, Passau (DE)

(73) Assignee: Karl-Otto Nickel, Passau (DE)

(21) Appl. No.: 13/265,928

(22) PCT Filed: Apr. 22, 2010
(86) PCT No.: PCT/EP2010/055402

§ 371 Date: Nov. 18, 2011

(30) Foreign Application Priority Data
Apr. 22, 2009 (DE) 20 2009 005 595.6

(51) Int. Cl. F21L 4/00

(52) U.S. Cl. 362/183

(57) ABSTRACT

Pendant 1 having a base body 4 with a front side 2 and a back side 3 and an element individualizing the pendant arranged on the base body 4, such that the element individualizing the pendant is designed as a lenticular object 5.

The invention relates to a pendant having a base body with a front side and a back side and an element individualizing the pendant and arranged on the base body according to the preamble of the main claim 1.

Such pendants are known in the prior art in a variety of embodiments. For example, there are pendants having a base body for key rings or for necklaces. An element that individualizes the pendant, for example, in the form of a stick-on label or an engraved inscription, may be provided on the base body of a pendant known from the prior art in order to impart a special note and/or a special appearance to the pendant.

The element individualizing the pendant and applied to the base body, for example, in the form of a stick-on label may have a photograph, for example. Furthermore, it is also conceivable that an engraved inscription, for example, the name of a spouse or the like, may be provided on the base body of the pendant in order to impart a special and individual note to the pendant itself.

Such pendants known from the prior art fulfill their purpose in an adequate manner.

However, against the background of such pendants as described above, the object of the present invention is to propose a novel pendant having an element individualizing the pendant, which will be further upgraded and will provide additional functions that permit an individualization of same beyond the known measures.

This object is achieved according to the present invention by the fact that the element which individualizes the pendant and is arranged on the base body of the pendant is embodied as a lenticular object.

A lenticular object in the sense of the present patent application is understood to be an element which has a visual effect and is embodied as a lenticular image or as a prismatic image, such that the lenticular object creates for the observer a three-dimensional impression of the object or image thereby represented. By means of such a lenticular system, it is possible to display several different images or items of information in a single lenticular object. The number of different image phases is determined by the size of the lens and the image resolution of the lenticular object. Through a change in the viewing angle of the observer in relation to the lenticular object, a movement in the image itself is in particular achieved and/or different images or items of information may be displayed for the observer in alternation.

Several different images or items of information may be stored here, in which case a movement sequence of an athlete or the emblem of a soccer team and information pertaining to the soccer team, for example, may be used and may then be displayed in alternation for the observer.

The use of a lenticular object as the element individualizing the pendant thus has the advantage that, first of all, it creates a greater range of possibilities for individualizing the pendant because different types of images and information and/or image sequences may be stored. In addition, the use of the lenticular object also creates the option of accommodating a great deal of information, which may be visible for the observer or not, depending on the viewing angle, and to display this information on a limited area of the base body of the pendant, which is available for this purpose.

Additional advantages are derived from the embodiments of the subject matter of the invention, as described in the dependent claims.

According to an advantageous embodiment of the pendant according to the present invention, the lenticular object is arranged on the front side of the base body of the pendant. The back side of the pendant may be embodied as a flat surface. This makes it possible to display various images for the observer by means of the lenticular object arranged on the front side, while additional data and information, for example, information characterizing the wearer of the pendant or additional information with respect to the image presented by the lenticular object on the front side, may be provided on the back side, for example, in the form of an engraved inscription or in the form of a traditional stick-on label.

According to another advantageous embodiment of the subject matter of the invention, a lenticular object is also arranged on the back side of the base body. This advantageously makes it possible to accommodate twice as much information because, depending on its viewing angle, the lenticular object displays different images and, consequently, views to the observer on the back side of the pendant after turning the pendant.

At least one ventricular object is preferably physically bonded to the base body. In particular the lenticular object may be glued to the base body.

In addition, however, it is also conceivable for the lenticular object to preferably be arranged on a carrier plate, which can be detachably connected to the base body in a formfitting manner and preferably also detachably. However, the lenticular object may also be connectable to the base body in a form-fitting manner even without a carrier plate. It is conceivable for the carrier plate, which supports the lenticular object, to be clipped into corresponding recesses in the base body. Alternatively, it would also be possible to provide latches on the carrier plate, which engage in corresponding catch recesses in the base body. The latches are preferably designed so that the lenticular object together with the carrier plate can be released from the base body. This has the advantage that the element which individualizes the pendant and is embodied as a lenticular object can be removed from the base body and replaced with an alternative lenticular object. For example, it is conceivable to embody the pendant as a fan object, whereby the lenticular object represents the emblem of a soccer team of the national league, which is designed to be different depending on the viewing angle of the observer, or whereby, in addition to the emblem of the club, additional data (the date the club was established, the number of team members and the current soccer players, for example) may be shown on the lenticular object and thus presented to the user to be seen in alternation with the emblem, depending on the viewing angle. A lenticular object designed in this way may then be replaced by an alternative lenticular object, for example, that of a different soccer team, if the lenticular object is connected to the base body in a form-fitting but releasable manner.

According to another specific embodiment of the pendant according to the invention, it is preferably embodied as a round medallion. A medallion in the sense of the present patent application should be understood to refer, first, to a flat one-piece base body as well as, on the other hand, a two-piece base body, such that the front side can be closed on the whole by means of a closing cover so that the lenticular object comes to lie beneath the closing cover in a concealed state of the medallion and is visible only when the closing cover is opened.

The base body of the pendant here may also have a shape other than a round shape, such that a round shape in the sense of the patent application is understood to be a circular shape as well as an oval shape. For example, the pendant may be polygonal, preferably hexagonal.

The lenticular object is preferably arranged centrally on the base body. According to a particular embodiment of the subject matter of the present invention, the lenticular object may be designed to be smaller than the base body so that this yields a free area between the peripheral edge of the lenticular object and the peripheral edge of the base body; this area may be provided with additional decorations, for example, in the form engraved inscriptions or an imprint.

In a refinement of the pendant according to the invention, a holder, in particular in the form of an eye, is preferably provided on the outer edge of the base body. The pendant may be worn around the neck or attached to other objects by means of a ribbon which is passed through the eye and may be embodied in the colors of the soccer team whose emblem is displayed through the lenticular object.

According to another embodiment of the subject matter of the invention, the base body is made of a metallic material, which is preferably finished at the surface or is made of plastic. This yields numerous possibilities in particular for embossing the back side, which is designed as a flat surface, and/or shaping it by embossing. The base body together with information on the back side can also be manufactured easily by traditional injection molding methods.

According to a particular refinement of the subject matter of the invention, the front side and/or the back side of the base body has/have at least one lamp or bulb. The use of LEDs (light-emitting diodes) is proposed in particular because LEDs are available in all sizes and can be used in a very flexible manner. In addition, LEDs have a very low power consumption. However, all other types of suitable lamps and bulbs are also conceivable, for example, those including passive phosphorescent elements. At least one lamp or bulb may be arranged on the base body between at least one ventricular [sic] object and the base body and/or next to at least one lenticular object. With the former arrangement, a particular lighting effect as a so-called background light can be created by the lamp or bulb itself. In addition, however, according to the arrangement mentioned in second place, it is also conceivable to provide a number of lamps and bulbs around the lenticular object and thereby achieve a particular lighting effect.

To operate at least one lamp or bulb if these are electrically operated lamps and bulbs, the base body has a closable recess which holds an electrical power source, in particular a rechargeable battery. The lamps and bulbs can be connected to this electrical power source to provide the required electrical power for operating the lamps and bulbs. In addition to a rechargeable battery, all conceivable electrical power sources, for example, an integrated battery, are of course also conceivable.

In another embodiment according to the invention, the pendant according to the invention may also be embodied as part of a belt, for example, in combination with the closure on the belt. It is conceivable to provide the closures on the belt with a corresponding receptacle in which the pendant is accommodated and can preferably be attached releasably, for example, using latches on the closure and complementary catch protrusions on the pendant. However, other possibilities for fastening the pendant to the closure are also conceivable. For example, a plurality of eyes through which the belt passes may also be provided on the pendant.

Alternatively, the pendant may also be embodied as part of a sash. To do so, it is conceivable for the pendant to preferably have fastening means in the form of a safety clasp, for example, preferably on its back side, with which it can be attached to the sash. It is also conceivable to provide a plurality of eyes on the pendant through which the sash is passed.

Furthermore, it is conceivable to embody the pendant in the form of a brooch. Fastening means are preferably provided on the back side of the base body of the pendant to be able to attach the brooch-like pendant to the clothing of the wearer. The fastening means may be embodied in the form of a safety clasp or equivalent devices.

An exemplary embodiment of the invention is explained in greater detail below on the basis of drawings, in which

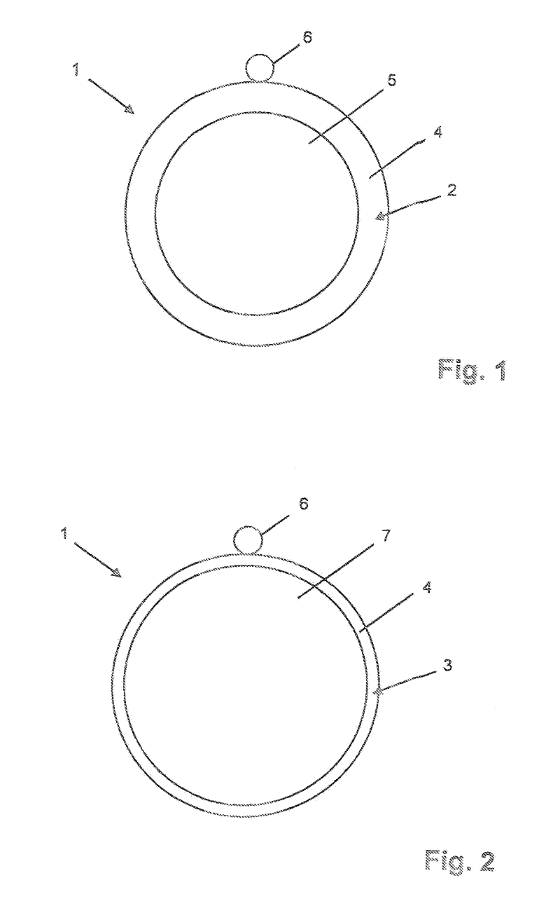

FIG. 1 shows a frontal view of the pendant according to the invention,

FIG. 2 shows a rear view of the pendant according to the invention in a first embodiment,

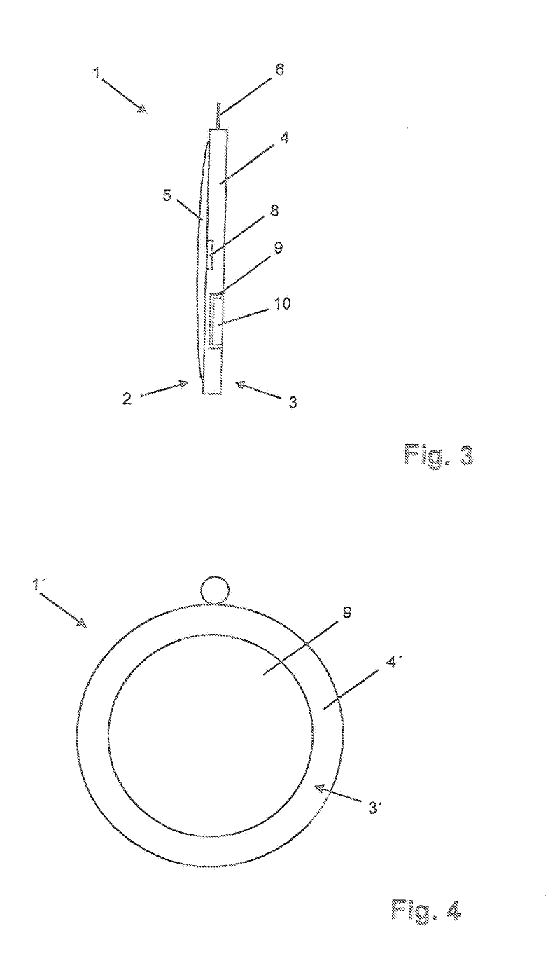

FIG. 3 shows a side view of the pendant according to the invention in the first embodiment, and

FIG. 4 shows a rear view of the pendant according to the invention in a second embodiment.

The pendant 1 according to the invention as shown in FIG. 1 has a base body 4 with a front side 2. The base body 4 is designed in a circular shape. A lenticular object 5 is arranged centrally on the front side 2 of the base body 4. Since the diameter of the lenticular object 5 is smaller than the diameter of the base body 4, this yields a peripheral ring on which an engraved inscription or at least one lamp and/or bulb may be provided. On the end of the base body 4 facing upward, an eye 6 is provided through which a ribbon (not shown) can be passed to hold the pendant 1 around the neck of the user, for example, or on a key ring.

The base body 4 of the pendant 1 according to the invention as shown in FIG. 2 also has a back side 3. The back side 3 has a flat surface 7. For example, engraved inscriptions may be provided in the flat surface 7 to provide additional information for the pendant 1. In addition, further information may also be applied to the flat surface 7 by means of stick-on labels or the like.

The pendant 1 according to the invention in the side view according to FIG. 3 shows the base body 4 as an element designed as a rectangle. The lenticular object 5 is arranged on the front side 2. The back side 3 is designed as a flat surface 7.

In addition, the base body 4 has a recess 9 in which an electrical power source 10 in the form of a rechargeable battery is situated. The recess 9 is closable. In addition, another recess, in which there is a lamp or bulb 8, is provided behind the lenticular object 5 in the base body 4. The lenticular object can be illuminated from the rear by means of the lamps and bulbs 8. The lamps and bulbs may be operated by a switch (not shown).

The alternative embodiment of the pendant 1′ according to FIG. 4 has all the features of the pendant 1 of the first embodiment, except for the design of the back side 3′. The back side 3′ of the base body 4′ of the pendant 1′ according to the second embodiment is not designed as a flat surface but instead has another lenticular object 9 comparable to the front side of the pendant 1′. This is designed and arranged like the lenticular object 5 on the front side.

1. A pendant having a base body with a front side and a back side and an element individualizing the pendant and arranged on the base body, characterized in that the element individualizing the pendant is designed as a lenticular object.

2. The pendant according to claim 1, characterized in that the lenticular object is arranged on the front side of the base body.

3. The pendant according to claim 2, characterized in that the back side of the base body is designed as a flat surface.

4. The pendant according to claim 2, characterized in that a second lenticular object is arranged on the back side of the base body.

5. The pendant according to claim 1, characterized in that at least one lenticular object is physically bonded to the base body.

6. The pendant according to claim 1, characterized in that at least one lenticular object ( )[sic] is connected in a form-fitting and preferably detachable manner to the base body.

7. The pendant according to claim 1, characterized in that at least one lenticular object is arranged centrally on the base body.

8. The pendant according to claim 1, characterized in that the base body is designed as preferably a round medallion.

9. The pendant according to claim 1, characterized in that the base body has a holder, in particular in the form of an eye, preferably on its outside edge.

10. The pendant according to claim 1, characterized in that the base body is made of a metallic material or plastic.

11. The pendant according to claim 1, characterized in that on the front side and/or on the back side of the base body at least one lamp or bulb is provided.

12. The pendant according to claim 11, characterized in that at least one lamp or bulb is arranged between at least one lenticular object and the base body and/or next to at least one lenticular object.

13. The pendant according to claim 11, characterized in that the base body has an electrical power source, in particular a rechargeable battery, which can be connected to at least one lamp or bulb and is arranged in a preferably closable recess.
